(19) United States
(12) Patent Application Publication
(10) Pub. No.: US 2014/0011937 A1
(43) Pub. Date: Jan. 9, 2014

(54) POLYPROPYLENE-BASED RESIN COMPOSITION FOR AUTOMOBILE PARTS, AND AUTOMOBILE EXTERIOR PARTS

(71) Applicants: Masahiro Nagata, Yokkaichi-shi (JP); Kenji Masuda, Yokkaichi-shi (JP); Yoshihiro Banno, Yokkaichi-shi (JP); Yasushi Okada, Yokkaichi-shi (JP); Masao Hara, Hiroshima-shi (JP); Masaaki Onishi, Higashi-Hiroshima-shi (JP); Chiaki Asano, Kure-shi (JP); Kazuhisa To, Hiroshima-shi (JP)

(72) Inventors: Masahiro Nagata, Yokkaichi-shi (JP); Kenji Masuda, Yokkaichi-shi (JP); Yoshihiro Banno, Yokkaichi-shi (JP); Yasushi Okada, Yokkaichi-shi (JP); Masao Hara, Hiroshima-shi (JP); Masaaki Onishi, Higashi-Hiroshima-shi (JP); Chiaki Asano, Kure-shi (JP); Kazuhisa To, Hiroshima-shi (JP)

(73) Assignee: MAZDA MOTOR CORPORATION, Hiroshima (JP)

(21) Appl. No.: 13/818,634

(22) PCT Filed: Mar. 28, 2012
(86) PCT No.: PCT/JP2012/002138

§ 371 Date: Feb. 22, 2013

(30) Foreign Application Priority Data
Mar. 29, 2011 (JP) 2011-071580

(51) Int. Cl. C08L 23/14

(52) U.S. Cl. CPC C08L 23/142
USPC 524/451; 264/328.1

(57) ABSTRACT

A polypropylene-based resin composition suitable for molding of especially an automobile bumper having good formability, high rigidity, excellent appearance, and high surface impact strength is provided. This composition includes: 30-62 wt. % of a propylene copolymer having an MFR of 40-70 g/10 min.; 5-20 wt. % of a propylene-based block copolymer including a crystalline polypropylene part having a high MFR and a specific ethylene-propylene copolymer part and having an MFR of 100-130 g/10 min; 10-20 wt. % of two types of ethylene-α-olefin copolymer elastomers each having a specific MFR and a specific density; and 23-30 wt. % of talc having a specific particle size.

### TECHNICAL FIELD

The present disclosure relates to polypropylene-based resin compositions for automobile parts, and automobile exterior parts of these components. The present disclosure relates more particularly to an automobile part polypropylene-based resin composition suitable for injection molding of, for example, an automobile exterior part having good formability, high rigidity, excellent appearance, and high surface impact strength, and to an automobile exterior part made of this component.

### BACKGROUND ART

Resin materials are currently used for many automobile exterior parts and other parts in view of weight reduction and formation flexibility. In recent years, further weight reduction has been demanded for environmental reasons, and accordingly, plastic bodies tend to be larger and thinner. Under this tendency, resin materials having high fluidity and good formability and capable of obtaining rigid plastic bodies have been needed. In obtaining such a resin material, impact strength, especially surface impact strength that is closely correlated to, and indicates, an impact resistance in actual use of a plastic body, is an important issue.

In general, the surface of a resin plastic body is coated to provide design properties thereto in many cases. On the other hand, many products are not coated for some reasons of formability and cost, and have colors of original resins. These products have defects in appearance, i.e., a tiger stripe called a flow mark or a tiger mark, due to an irregular flow of a molten resin.

An automobile exterior part plastic body entirely or locally having an uncoated portion, therefore, needs to improve the appearance (i.e., to have measures against flow marks) and enhance the surface impact strength described above.

Patent Document 1 shows a technique related to measures against flow marks. In Patent Document 1, a component capable of reducing occurrence of flow marks is not added in the process of compounding but is added in a small amount in the form of masterbatch in the process of formation. This technique provides a polypropylene resin composition to which a component necessary only for a part having an uncoated portion is added at a minimum cost, a plastic body using the resin composition, and a method for producing the resin composition. Patent Document 1 describes a polypropylene resin composition containing: 2-15 wt. % of a moldability improver formed of a propylene-based block copolymer having a high MFR in a propylene homopolymer component and a propylene-based block copolymer having a high content of a propylene-ethylene random copolymer component; and a 85-98 wt. % of a polypropylene-based resin composition formed of a propylene-ethylene block copolymer, an elastomer, and an inorganic filler.

Patent Documents 2 and 3 propose polyolefin resin compositions showing reduced occurrence of flow marks and having excellent surface impact properties and plastic bodies made of the polyolefin resin compositions. Each of the polyolefin resin compositions of Patent Documents 2 and 3 includes 70-90 wt. % of a propylene polymer (A) and 10-30 wt. % of an inorganic filler (B). The propylene polymer (A) contains: 60-75 wt. % of a crystalline propylene component as a propylene homopolymer or a copolymer of propylene and either 1 mol. % or less of ethylene or α-olefin having a carbon number of four or more; and 25-40 wt. % of a propylene-ethylene random copolymer component whose weight ratio between propylene and ethylene (propylene/ethylene (weight/weight)) is 75/25-35/65, and satisfies specific requirements.

Although Patent Document 1 shows reduced occurrence of flow marks, the techniques proposed in embodiments thereof do not reach the current level of formation of thin plastic bodies requiring high degrees of a melt flow rate (MFR) and rigidity. In addition, Patent Document 1 fails to teach or suggest the surface impact strength. Patent Document 2 shows reduced occurrence of flow marks, but any embodiment thereof shows a relatively low flowability. In addition, Patent Document 2 not only teaches none of an impact property and the surface impact strength in a low-temperature range (e.g., −30° C.) which is an important temperature range for automobile exterior parts, but also shows insufficient enhancement of the surface impact strength in a room temperature range described in Patent Document 2. Patent Document 3 shows reduced occurrence of flow marks and an enhanced surface impact strength, but flowability and rigidity are insufficient in all the embodiments thereof. Formation of thinned plastic bodies as described above requires further improvement of resin compositions.

That is, as described in the above examples, it has been difficult for conventional polypropylene-based resin compositions for automobile parts to satisfy high levels of requirements in terms of obtaining good formability (high flowability), high rigidity, high surface impact strength, and excellent appearance (reduced occurrence of flow marks).

### CITATION LIST

### Patent Document

PATENT DOCUMENT 1: Japanese Patent Publication No. 2008-163120
PATENT DOCUMENT 2: Japanese Patent Publication No. 2008-208304
PATENT DOCUMENT 3: Japanese Patent Publication No. 2008-208306

### SUMMARY OF THE INVENTION

### Technical Problem

It is therefore an object of the present disclosure to provide an automobile part polypropylene-based resin composition suitable for injection molding of, for example, an automobile exterior part having good formability, high rigidity, excellent appearance, and surface impact strength, and an automobile exterior part made of this component.

Specifically, the present disclosure can solve the problems of occurrence of flow marks and insufficient surface impact strength as described above, and provides an automobile part polypropylene-based resin composition having good formability and property balance, and an automobile exterior part using this composition, especially an automobile bumper.

### Solution to the Problem

To solve the above-described problems, inventors of the present disclosure conducted various studies, and found that a specific propylene copolymer combined with: a propylene-based block copolymer having a specific ethylene content; a specific ethylene-α-olefin copolymer elastomer containing two types of components having different MFRs and different densities in a specific ratio; and talc having a specific average particle size in a specific ratio can obtain a polypropylene-based resin composition superior to conventional materials in terms of appearance, rigidity, and surface impact strength, to arrive at the invention.

Specifically, a polypropylene-based resin composition for an automobile part includes: 30-62 wt. % of a component (I); 5-20 wt. % of a component (II); 10-20 wt. % of a component (III); and 23-30 wt. % of a component (IV) (where a total amount of the components (I)-(IV) is 100 wt. %), an MFR (at 230° C. under a load of 21.18 N) of the polypropylene-based resin composition is 35-50 g/10 min., and a bending modulus of the polypropylene-based resin composition is 2000-2700 MPa.

The component (I) is a propylene copolymer including 85-75 wt. % of a crystalline polypropylene part (I₁) and 15-25 wt. % of an ethylene-propylene copolymer part (I₂) having an ethylene content of 30-45 wt. % (where a total amount of the parts (I₁) and (I₂) is 100 wt. %), and an MFR (at 230° C. under a load of 21.18 N) of the entire component (I) is 40-70 g/10 min.

The component (II) is a propylene-based block copolymer including 85-95 wt. % of a crystalline polypropylene part (II₁) having an MFR (at 230° C. under a load of 21.18 N) of 250-350 g/10 min. and 5-15 wt. % of an ethylene-propylene copolymer part (II₂) having an ethylene content of 25-40 wt. % and an intrinsic viscosity of 6-8 dl/g (where a total amount of the parts (II₁) and (II₂) is 100 wt. %), and an MFR (at 230° C. under a load of 21.18 N) of the entire component (II) is 100-130 g/10 min.

The component (III) is an ethylene-α-olefin copolymer elastomer including an ethylene-α-olefin copolymer elastomer (III-A) having an MFR (at 230° C. under a load of 21.18 N) of 0.5-1.5 g/10 min. and a density of 0.860-0.867 g/cm³, and an ethylene-α-olefin copolymer elastomer (III-B) having an MFR of 5-10 g/10 min. and a density of 0.860-0.867 g/cm³, and a weight ratio ((III-A)/(III-B)) between the elastomers (III-A) and (III-B) is 3/7-7/3.

The component (IV) is talc having an average particle size of 3.5-10 μm.

Preferably, in this polypropylene-based resin composition, a content of the component (I) is 39-57 wt. %, a content of the component (II) is 8-15 wt. %, a content of the component (III) is 12-18 wt. %, and a content of the component (IV) is 23-28 wt. %.

In this polypropylene-based resin composition, an ethylene content of the ethylene-propylene copolymer part (II₂) in the component (II) is preferably 30-40 wt. %.

An automobile exterior part can be obtained by performing injection molding on the polypropylene-based resin composition including the components (I)-(IV).

### Advantages of the Invention

A polypropylene-based resin composition for an automobile part according to the present disclosure is suitable for injection molding of, for example, an automobile exterior part having good formability, high rigidity, excellent appearance, and high surface impact strength. An automobile exterior part according to the present disclosure is made of the polypropylene-based resin composition, and has excellent properties and appearance.

### DESCRIPTION OF EMBODIMENTS

A polypropylene-based resin composition for an automobile part (hereinafter also referred to as a polypropylene-based resin composition) according to the present disclosure is a resin composition including: a propylene copolymer (hereinafter also referred to as a component (I)) containing a crystalline polypropylene part (I₁) and an ethylene-propylene copolymer part (I₂); a propylene-based block copolymer (hereinafter also referred to as a component (II)) containing a crystalline polypropylene part (II₁) and an ethylene-propylene copolymer part (II₂); an ethylene-α-olefin copolymer elastomer (hereinafter also referred to as a component (III)); and talc (hereinafter also referred to as a component (IV)).

Components of a polypropylene-based resin composition, a method for producing a polypropylene-based resin composition, and formation, properties, and applications of the polypropylene-based resin composition and an automobile exterior part made of the polypropylene-based resin composition, will be specifically described hereinafter.

1. Components of Polypropylene-Based Resin Composition

### (1) Propylene Copolymer

A propylene copolymer (the component (I)) for use in a polypropylene-based resin composition according to the present disclosure is a propylene copolymer obtained by sequentially polymerizing the crystalline polypropylene part (I₁) and the ethylene-propylene copolymer part (I₂).

The MFR of the entire propylene copolymer (the component (I)) is 40-70 g/10 min. and preferably 45-65 g/10 min. If the MFR is less than 40 g/10 min., the formability (flowability) of the polypropylene-based resin composition might be poor. IF the MFR exceeds 70 g/10 min., the surface impact strength and further the tensile extensibility might decrease.

Here, measurement of the MFR conforms to JIS K 7210, and is performed at 230° C. under a load of 21.18 N. The MFR herein is measured in the same manner unless otherwise specified.

The proportion of the crystalline polypropylene part (I₁) in the entire propylene copolymer (the component (I)) is 85-75 wt. %. The proportion of the ethylene-propylene copolymer part (I₂) in the entire propylene copolymer (the component (I)) is 15-25 wt. %. If the proportion of the ethylene-propylene copolymer part (I₂) is less than 15 wt. %, the surface impact strength of the resultant plastic body might degrease. If the proportion of the ethylene-propylene copolymer part (I₂) exceeds 25 wt. %, the rigidity of the resultant plastic body might decrease.

The ethylene-propylene copolymer part (I₂) in the component (I) has an ethylene content of 30-45 wt. %, preferably 35-43 wt. %. If the ethylene content is less than 30 wt. %, the surface impact strength of the resultant plastic body might decrease. If the ethylene content exceeds 45 wt. %, the surface impact strength might also decrease.

The proportions and ethylene contents of the above-described part (I₂) and the part (II₂) which will be described later are measured with, for example, cross fractionation apparatus or an FT-IR under conditions as disclosed in, for example, Japanese Patent Publication No. 2008-189893.

In the polypropylene-based resin composition according to the present disclosure, the content of the propylene copolymer (the component (I)) is 30-62 wt. % and preferably 39-57 wt. % where the total amount of the components (I)-(IV) is 100 wt. %.

If the content of the component (I) is less than 30 wt. %, the rigidity, for example, of the resultant plastic body might be insufficient. If the content of the component (I) exceeds 62 wt. %, the balance between the surface impact strength and the rigidity might deteriorate.

### (2) Propylene-Based Block Copolymer

The propylene-based block copolymer (the component (II)) for use in the polypropylene-based resin composition of the present disclosure is a propylene-based block copolymer obtained by sequentially polymerizing the crystalline polypropylene part (II₁) and the ethylene-propylene copolymer part (II₂).

The MFR of the entire propylene-based block copolymer (the component (II)) is 100-130 g/10 min. and preferably 100-120 g/10 min. If the MFR is less than 100 g/10 min., the formability (flowability) of the polypropylene-based resin composition and the appearance (e.g., occurrence of flow marks) might be poor. If the MFR exceeds 130 g/10 min., the surface impact strength and further the tensile extensibility might decrease.

The proportion of the crystalline polypropylene part (II₁) in the entire propylene-based block copolymer (the component (II)) is 85-95 wt. %. The proportion of the ethylene-propylene copolymer part (II₂) in the entire propylene-based block copolymer (the component (II)) is 5-15 wt. %. If the proportion of the part (II₂) is less than 5 wt. %, decrease in the surface impact strength and degradation of the appearance (e.g., occurrence of flow marks) might occur. On the other hand, if the proportion of the part (II₂) exceeds 15 wt. %, gelling is likely to occur, which might adversely affect the appearance (occurrence of flow marks) and the surface impact strength.

The crystalline polypropylene part MD in the component (II) has an MFR of 250-350 g/10 min., preferably 250-300 g/10 min. If the MFR is less than 250 g/10 min., occurrence of flow marks might degrade the appearance. If the MFR exceeds 350 g/10 min., the surface impact strength and further the tensile extensibility might decrease.

The ethylene-propylene copolymer part (II₂) in the component (II) has an ethylene content of 25-40 wt. %, preferably 30-40 wt. %. If the ethylene content is out of these ranges, the surface impact strength might decrease.

If the ethylene content is within the above ranges, the ethylene-α-olefin copolymer elastomer (the component (III)), which is another component of the polypropylene-based resin composition, is especially significantly finely dispersed. Together with advantages obtained by combining the ethylene-α-olefin copolymer elastomer (the component (III)) with two specific types of parts, which will be described later, the ethylene-α-olefin copolymer elastomer (the component (III)) is expected to exhibit excellent surface impact strength.

That is, according to the present disclosure, especially a combination of a feature in which the ethylene content is in the above-mentioned ranges and a feature in which the component (III) includes ethylene-α-olefin copolymer elastomers (III-A) and (III-B) each having a specific MFR and a specific density, is expected to obtain a polypropylene-based resin composition in which the ethylene-α-olefin copolymer elastomer (the component (III)) is finely dispersed, and to obtain novel advantages, especially high surface impact strength.

The ethylene-propylene copolymer part (II₂) has an intrinsic viscosity ([η]_{copoly}) in the range of 6-8 dl/g, preferably 7-8 dl/g. If the intrinsic viscosity is less than 6 dl/g, occurrence of flow marks might degrade the appearance. If the intrinsic viscosity exceeds 8 dl/g, the surface impact strength might decrease.

Here, the intrinsic viscosity is measured at 135° C. with an Ubbelohde viscometer using decalin as a solvent. To measure the viscosity, after polymerization of the crystalline polypropylene part MD, part of the polymerization product is sampled from a polymerization tank, and the intrinsic viscosity ([η]ₕₒₘₒ) is measured. In addition, after polymerization of the crystalline polypropylene part (II₁), the intrinsic viscosity [η]F of the final polymerization product (F) obtained by polymerizing the propylene-ethylene random copolymer part (II₂) is measured. The intrinsic viscosity [η]_{copoly} is calculated by the following expression:

[η]F=(100−Wc)/100×[η]ₕₒₘₒ+Wc/100×[η]_{copoly}

where Wc is the proportion (wt. %) of the propylene-ethylene random copolymer part (II₂) in the entire propylene-based block copolymer (the component (II)).

The component (II) can be produced through slurry polymerization, bulk polymerization, or gas-phase polymerization, using a highly stereoregular catalyst. Examples of the highly stereoregular catalyst include a catalyst including a combination of an organic aluminium compound and a solid constituent obtained by bringing magnesium chloride into contact with titanium tetrachloride, organic hydride, and an organic silane compound. As a polymerization technique, any one of batch polymerization or continuous polymerization may be employed.

The above-mentioned propylene copolymer (the component (I)) can be produced in a manner similar to that described above.

In the polypropylene-based resin composition of the present disclosure, the content of the propylene-based block copolymer (component (II)) is 5-20 wt. % and preferably 8-15 wt. % where the total amount of the components (I)-(IV) is 100 wt. %. If the content of the component (II) is less than 5 wt. %, occurrence of flow marks might degrade the appearance. If the content of the component (II) exceeds 20 wt. %, the surface impact strength and further the tensile extensibility might decrease.

### (3) Ethylene-α-Olefin Copolymer Elastomer

The ethylene-α-olefin copolymer elastomer (the component (III)) for use in the polypropylene-based resin composition of the present disclosure needs to include specific ethylene-α-olefin copolymer elastomers (III-A) and (III-B). Such an ethylene-α-olefin copolymer elastomer (the component (III)) is used to obtain enhanced impact resistance, good formability, excellent properties, and size stability, for example. In the component (III), examples of α-olefin that is copolymerized with ethylene include 1-octene and 1-butene.

Each of the above-described elastomers (III-A) and (III-B) can be produced by polymerizing monomers as a material for the elastomer (III-A) or (III-B) in the presence of a catalyst. Examples of the catalyst include a titanium compound such as titanium halide, an organic aluminium-magnesium complex such as an aluminium alkyl-magnesium complex, a so-called Ziegler catalyst such as aluminium alkyl or aluminum alkyl chloride, and a metallocene compound catalyst described in, for example, WO 91/04257. As a polymerization technique, polymerization can be carried out by applying a production process such as a process using a gas-phase fluidized bed, a solution process, or a slurry process.

In the ethylene-α-olefin copolymer elastomer (the component (III)) employed in the present disclosure, the elastomer (III-A) has an MFR of 0.5-1.5 g/10 min. and the elastomer the elastomer has an MFR of 5-10 g/10 min. If the MFRs are out of these ranges, the polypropylene-based resin composition might have poor formability (flowability) or an insufficient surface impact strength which is especially important for the resultant plastic body.

In the component (III) employed in the present disclosure, the elastomer (III-A) has a density of 0.860-0.867 g/cm³ and the elastomer (III-B) has a density of 0.860-0.867 g/cm³. If the densities are out of these ranges, the resultant plastic body might have an insufficient surface impact strength. Thus, it is not preferable that the density is out of the above ranges.

In the component (III) employed in the present disclosure, the weight ratio ((III-A)/(III-B)) between (III-A) and (III-B) in the entire component (III) is 3/7-7/3. If the weight ratio between (III-A) and (III-B) is out of this range, the surface impact strength might be insufficient.

In the polypropylene-based resin composition, the content of the component (III) is 10-20 wt. % and preferably 12-18 wt. % where the total amount of the components (I)-(IV) is 100 wt. %. If the content of the component (III) is less than 10 wt. %, the surface impact strength might be insufficient. If the content of the component (III) exceeds 20 wt. %, the rigidity might be insufficient.

### (4) Talc

The talc (the component (IV)) for use in the polypropylene-based resin composition of the present disclosure has an average particle size of 3.5-10 μm. As long as the average particle size is within this range, the resultant polypropylene-based resin composition has excellent appearance (reduced occurrence of flow marks) and high rigidity.

The component (IV) is produced by, for example, pulverizing a talc raw material with an impact pulverizer or a micron mill pulverizer and/or further pulverizing the material with a jet mill, and then classifying the pulverized material with, for example, a cyclone or a micron separator. The average particle size of talc can be measured under standard conditions using a laser diffraction/scattering particle size distribution analyzer (e.g., LA-920 produced by HORIBA, Ltd.).

Alternatively, so-called compressed talc having an apparent specific volume of 2.5 ml/g or less may be used. This talc may be talc subjected to a surface treatment using metallic soap, paraffin wax, polyethylene wax, denatured substances thereof, organic silane, organic borane, or organic titanate, for example.

In the polypropylene-based resin composition of the present disclosure, the content of talc (the component (IV)) is 23-30 wt. % and preferably 23-28 wt. % where the total amount of the components (I)-(IV) is 100 wt. %. If the content of the component (IV) is less than 23 wt. %, the polypropylene-based resin composition might have insufficient rigidity and insufficient thermal resistance. If the content of the component (IV) exceeds 30 wt. %, the surface impact strength and the appearance (occurrence of flow marks) might deteriorate.

### (5) Other Ingredients (Arbitrary Components)

The propylene-based resin composition of the present disclosure may additionally include an arbitrary component listed below within the range where advantages of the present disclosure are not impaired or in order to further enhance properties thereof. Specifically, examples of the arbitrary component include an antioxidant, an antistat, a light stabilizer, an ultraviolet radiation absorber, a lubricant, a nucleating agent, a flame retardant, a dispersing agent, a pigment, and a foaming agent.

2. Production and Properties of Polypropylene-Based Resin Composition

The polypropylene-based resin composition of the present disclosure can be produced by blending/mixing, melting, and kneading the components (I)-(IV) (and other ingredients when necessary) in the above-described ratio by a known method. For example, the polypropylene-based resin composition of the present disclosure may be obtained by kneading and granulating the components (I)-(IV) (and other ingredients when necessary) with a general kneader such as a single screw extruder, a twin screw extruder, a Banbury mixer, a roll mixer, a Brabender plastograph, or a kneader.

In this case, a kneading and granulating technique capable of obtaining good dispersion of each component is preferably selected, and a twin screw extruder is employed in general. In this kneading and granulating technique, all the above-described components may be kneaded at the same time, or the components may be divided into parts so that the components are kneaded parts by parts. Specifically, part or all of the propylene polymer (the component (I)) and the ethylene-α-olefin copolymer elastomer (the component (III)) are kneaded, and then the other components are kneaded and granulated, for example.

Since the polypropylene-based resin composition of the present disclosure has an MFR of 35-50 g/10 min., preferably 40-50 g/10 min., good injection molding formability can be achieved. This composition can be used for producing a plastic body having a bending modulus of 2000-2700 MPa, preferably 2100-2700 MPa and more preferably 2200-2700 MPa to have high rigidity, and exhibiting excellent appearance (reduced occurrence of flow marks) and high surface impact strength. The bending modulus is measured in conformity with ISO 178.

3. Production and Properties of Automobile Exterior Part

The automobile exterior part of the present disclosure can be obtained by molding the polypropylene-based resin composition produced in the above-described manner with a known technique such as injection molding (including gas injection molding), and injection compression molding (press injection).

As described above, the polypropylene-based resin composition of the present disclosure is suitable for producing a plastic body having good formability, high rigidity, excellent appearance, and high surface impact strength. Thus, according to the present disclosure, an automobile exterior part sufficient for actual use of thin and large bumpers with high functionality, for example.

### EXAMPLES

Examples and comparative examples of the polypropylene-based resin composition and the automobile exterior part of the present disclosure will be specifically described hereinafter. The present disclosure is not limited to these examples and comparative examples. The examples and comparative examples used the following materials and test and evaluation methods.

### 1. Evaluation Method

(1) MFR: measured in conformity with JIS K 7210
(2) Bending modulus (unit: MPa): measured at 23° C. in conformity with ISO 178
(3) Appearance: A molded sheet having a size of 350 mm×105 mm and a thickness of 2 mm was injection molded at 220° C. with an injection molding machine having a clamping pressure of 170 tons using a mold having, at its shorter side, a fan gate with a width of 30 mm and a thickness of 0.8 mm In this molding, occurrence of flow marks was visually observed, and the distance from the gate to a place where a flow mark occurs was measured. The determination was made based on the following criteria:
∘: 160-240 mm
Δ: 120-160 mm
x: less than 120 mm
(4) Surface impact strength: A sheet having a size of 120 mm×120 mm and a thickness of 3 mm was obtained by injection molding with a Hydroshot HITS-P10 produced by SHIMADZU CORPORATION. After being held in a thermostat of the machine in an atmosphere of −30° C. for one hour or more, the sheet was fixed with a holder having a 40-mmφ hole, and then was destroyed at a test speed of 4.4 m/s with a striker having a 20-mmφ spherical surface at the tip thereof. All the energy consumed in this destruction was measured, thereby determining the surface impact strength based on the following criteria:
∘: 45 J or more

### Δ: 35-45 J

x: less than 35 J

### 2. Materials

### (1) Propylene Copolymer (Component (I))

Propylene copolymers (I)-1 and (I)-2 shown in Table 1 were used.

### (2) Propylene-Based Block Copolymer (Component (II))

Propylene-based block copolymers (II)-1-(II)-3 shown in Table 2 were used.

### (3) Ethylene-α-Olefin Elastomer (Component (III))

Ethylene-α-olefin elastomers (III)-1-(III)-4 shown in Table 3 were used.

### (4) Talc (Component (IV))

Talc with an average particle size of 5 μm obtained with an LA920 was used.

TABLE 1

| | propylene copolymer component (I) | | | |
|---|---|---|---|---|
| | | crystalline | ethylene-propylene | |
| | | polypropylene | copolymer part (I₂) | |
| | MFR | part (I₁) | | ethylene content |
| | g/10 min | content (wt. %) | content (wt. %) | (wt. %) |
| (I)-1 | 50 | 80 | 20 | 35 |
| (I)-2 | 70 | 85 | 15 | 40 |

TABLE 2

| | propylene-based block copolymer | | | | | |
|---|---|---|---|---|---|---|
| | component (II) | | | | | |
| | | crystalline | | | | |
| | | polypropylene | | ethylene-propylene | | |
| | | part (II₁) | | copolymer part (II₂) | | |
| | | | MFR | | ethylene | intrinsic |
| | MFR | content | (g/10 | content | content | viscosity |
| | g/10 min | (wt. %) | min.) | (wt. %) | (wt. %) | (dl/g) |
| (II)-1 | 115 | 90 | 300 | 10 | 33 | 8.0 |
| (II)-2 | 50 | 80 | 300 | 20 | 45 | 6.5 |
| (II)-3 | 110 | 85 | 200 | 15 | 45 | 2.2 |

TABLE 3

| | | ethylene-α-olefin copolymer elastomer | | |
|---|---|---|---|---|
| | | component (III) | | |
| | | MFR (g/10 min) | comonomer type | density (g/cm³) |
| (III)-A | (III)-1 | 1.0 | 1-octene | 0.863 |
| (III)-B | (III)-2 | 6.7 | 1-butene | 0.864 |
| others | (III)-3 | 2.2 | 1-butene | 0.870 |
| | (III)-4 | 1.0 | 1-octene | 0.868 |

### 3. Examples and Comparative Examples

### Examples 1-3 and Comparative examples 1-9

The above-described components were dry blended with a super mixer in a ratio shown in Table 4, and then were melted and kneaded at an extrusion temperature of 200° C. with a discharge amount of 80 kg/h with a twin screw extruder (produced by Kobe Steel, Ltd. (Kobelco Construction Machinery Co., Ltd., KCM)). As heat stabilizers for the melting and kneading, 0.1 part by weight of tetrakis [methylene-3-(3′5′-di-t-butyl-4′-hydroxyphenyl)propionate]methane (produced by Nihon Ciba-Geigy K.K., trade name: Irganox 1010) and 0.05 parts by weight of tris(2,4-di-t-butylphenyl)phosphite (produced by Nihon Ciba-Geigy K.K., trade name: Irgafos 168), with respect to 100 parts by weight of the above-described compositions which had been dry blended, were blended. After the melting and kneading, test samples were produced by injection molding (at 200° C., mold temperature: 40° C.), and evaluation was carried out. Table 4 shows the results.

TABLE 4

| | | | | example | | | comparative example | | | | | | | | |
|---|---|---|---|---|---|---|---|---|---|---|---|---|---|---|---|
| | | | | 1 | 2 | 3 | 1 | 2 | 3 | 4 | 5 | 6 | 7 | 8 | 9 |
| composition | propylene | (I)-1 | wt. % | 50 | 45 | | 60 | | 50 | 50 | 50 | | | 50 | |
| | copolymer component (I) | (I)-2 | wt. % | | | 55 | | 60 | | | | 55 | 55 | | 45 |
| | propylene-based block | (II)-1 | wt. % | 10 | 15 | 5 | | | | | 10 | 5 | 5 | 15 | 5 |
| | copolymer component (II) | (II)-2 | wt. % | | | | | | 10 | | | | | | |
| | | (II)-3 | wt. % | | | | | | | 10 | | | | | |
| | ethylene-α-olefin | (III)-1 | wt. % | 5 | 10 | 10 | 5 | 10 | 5 | 5 | | | | 6 | 5 |
| | copolymer elastomer | (III)-2 | wt. % | 10 | 5 | 5 | 10 | 5 | 10 | 10 | 15 | | 5 | 12 | 10 |
| | component (III) | (III)-3 | wt. % | | | | | | | | | 15 | | | |
| | | (III)-4 | wt. % | | | | | | | | | | 10 | | |
| | talc component (IV) | | wt. % | 25 | 25 | 25 | 25 | 25 | 25 | 25 | 25 | 25 | 25 | 17 | 35 |

| | | | | | | | | | | | | | | |
|---|---|---|---|---|---|---|---|---|---|---|---|---|---|---|
| properties | MFR | g/10 min | 40 | 40 | 41 | 35 | 40 | 33 | 38 | 43 | 42 | 40 | 38 | — |
| | bending modulus | MPa | 2270 | 2310 | 2370 | 2150 | 2290 | 2180 | 2230 | 2280 | 2400 | 2420 | 1820 | — |
| | surface impact strength | — | ∘ | ∘ | ∘ | ∘ | x | ∘ | Δ | x | x | x | ∘ | — |
| | (−30° C.) | | | | | | | | | | | | | |
| | flow mark | — | ∘ | ∘ | ∘ | x | Δ | x | x | ∘ | ∘ | ∘ | ∘ | x |

### 4. Evaluation

As shown in Table 4, in Examples 1-3 satisfying requirements: “including 30-62 wt. %, of the component (I), 5-20 wt. % of the component (II), 10-20 wt. % of the component (III), and 23-30 wt. % of the component (IV),” which are maters specifying the automobile part polypropylene-based resin composition of the present disclosure, plastic bodies having good formability (flowability=MFR), high rigidity, excellent appearance (reduced occurrence of flow marks), and high surface impact strength were obtained.

On the other hand, regarding comparative examples not satisfying the above maters specifying the present disclosure, comparative example 1 not including propylene-based block copolymer (the component (II)) showed inferior reduction of occurrence of flow marks. Comparative example 2 not including the component (II) showed inferior reduction of occurrence of flow marks. Comparative example 3 not satisfying the requirements for the MFR of the entire copolymer of the component (II) and the proportion and ethylene content of the ethylene-propylene copolymer part (II₂), showed poor flowability, inferior reduction of occurrence of flow marks, and inferior rigidity. The comparative example 4 in which the MFR of the crystalline polypropylene part (II₁) of component (II) and the ethylene content and intrinsic viscosity of the ethylene-propylene copolymer part (II₂) did not satisfy the requirements of the present disclosure, showed inferior reduction of occurrence of flow marks and inferior surface impact strength. Comparative example 5 including only one type of ethylene-α-olefin copolymer elastomer showed inferior surface impact strength. Comparative example 6 including one type of ethylene-α-olefin copolymer elastomer and not satisfying the density requirement, showed inferior surface impact strength. Comparative example 7 not satisfying the density requirement for the component (III-4) showed inferior surface impact strength. Comparative example 8 in which the content of talc was smaller than that required in the present disclosure, showed inferior rigidity. Comparative example 9 in which the content of talc was larger than that required in the present disclosure, showed inferior reduction of occurrence of flow marks. In comparative example 9, since reduction of occurrence of flow marks was distinctly inferior to the other examples, other items were not evaluated.

Accordingly, Examples 1-3 showed excellent results in which a plastic body having good formability, high rigidity, excellent appearance (reduced occurrence of flow marks), and high surface impact strength can be obtained by adjusting specific components and the contents thereof, which are matters specifying the present disclosure, in a polypropylene-based resin composition and a plastic body of the composition.

### INDUSTRIAL APPLICABILITY

A polypropylene-based resin composition according to the present disclosure can be used for producing a plastic body having good formability, high rigidity, excellent appearance, and high surface impact strength, and has properties sufficient for actual use of thin and large bumpers with high functionality, for example. An automobile exterior part according to the present disclosure may be made of the above composition, and has excellent properties and appearance. Accordingly, the automobile part polypropylene-based resin composition and the automobile exterior part of the present disclosure are significantly useful for industrial application.

1. A polypropylene-based resin composition for an automobile part, the polypropylene-based resin composition comprising:
30-62 wt. % of a component (I);
5-20 wt. % of a component (II);
10-20 wt. % of a component (III); and
23-30 wt. % of a component (IV) (where a total amount of the components (I)-(IV) is 100 wt. %), wherein
an MFR (at 230° C. under a load of 21.18 N) of the polypropylene-based resin composition is 35-50 g/10 min.,
a bending modulus of the polypropylene-based resin composition is 2000-2700 MPa,
the component (I) is a propylene copolymer including
85-75 wt. % of a crystalline polypropylene part (I₁) and
15-25 wt. % of an ethylene-propylene copolymer part (I₂) having an ethylene content of 30-45 wt. % (where a total amount of the parts (I₁) and (I₂) is 100 wt. %),
an MFR (at 230° C. under a load of 21.18 N) of the entire component (I) is 40-70 g/10 min.,
the component (II) is a propylene-based block copolymer including
85-95 wt. % of a crystalline polypropylene part MD having an MFR (at 230° C. under a load of 21.18 N) of 250-350 g/10 min. and
5-15 wt. % of an ethylene-propylene copolymer part (II₂) having an ethylene content of 25-40 wt. % and an intrinsic viscosity of 6-8 dl/g (where a total amount of the parts MD and (II₂) is 100 wt. %),
an MFR (at 230° C. under a load of 21.18 N) of the entire component (II) is 100-130 g/10 mM,
the component (III) is an ethylene-α-olefin copolymer elastomer including
an ethylene-α-olefin copolymer elastomer (III-A) having an MFR (at 230° C. under a load of 21.18 N) of 0.5-1.5 g/10 min. and a density of 0.860-0.867 g/cm³, and
an ethylene-α-olefin copolymer elastomer (III-B) having an MFR of 5-10 g/10 min. and a density of 0.860-0.867 g/cm³,
a weight ratio ((III-A)/(III-B)) between the elastomers (III-A) and (III-B) is 3/7-7/3, and
the component (IV) is talc having an average particle size of 3.5-10 μm.

2. The polypropylene-based resin composition of claim 1, wherein
a content of the component (I) is 39-57 wt. %,
a content of the component (II) is 8-15 wt. %,
a content of the component (III) is 12-18 wt. %, and
a content of the component (IV) is 23-28 wt. %.

3. The polypropylene-based resin composition of claim 1, wherein
an ethylene content of the ethylene-propylene copolymer part (II₂) in the component (II) is 30-40 wt. %.

4. An automobile exterior part, obtained by performing injection molding on the polypropylene-based resin composition of claim 1.

5. The polypropylene-based resin composition of claim 2, wherein
an ethylene content of the ethylene-propylene copolymer part (II₂) in the component (II) is 30-40 wt. %.

6. An automobile exterior part, obtained by performing injection molding on the polypropylene-based resin composition of claim 2.

7. An automobile exterior part, obtained by performing injection molding on the polypropylene-based resin composition of claim 3.

8. An automobile exterior part, obtained by performing injection molding on the polypropylene-based resin composition of claim 5.
